(19) United States
(12) Patent Application Publication
(10) Pub. No.: US 2004/0062206 A1
(43) Pub. Date: Apr. 1, 2004

(54) System and method for fast reverse link scheduling in a wireless communication network

(76) Inventors: Anthony C.K. Soong, Superior, CO (US); Aleksandar D. Damnjanovic, San Diego, CA (US); Seong-Jun Oh, San Diego, CA (US)

Correspondence Address: COATS & BENNETT, PLLC, P O BOX 5, RALEIGH, NC, 27602, US

(21) Appl. No.: 10/261,361

(22) Filed: Sep. 30, 2002

(51) Int. Cl. H04J 1/16; H04Q 7/00

(52) U.S. Cl. 370/252; 370/328

(57) ABSTRACT

By using portions of their reverse pilot signals, mobile stations report relevant state information to supporting radio base stations (RBSs) such that reverse link scheduling decisions may be made quickly at the RBS level rather than by an associated base station controller. Moving reverse link scheduling to the RBS level greatly increases the speed of scheduling decisions, such that a wireless network gains efficiency through greater scheduling responsiveness. In exemplary embodiments, “pilot stealing” for state information transmission is balanced against the network's need for unmodulated pilot signals from the mobile stations to use in channel estimation operations and carrier synchronization. “Stolen” portions of a given mobile station's pilot signal may be used to indicate that, for example, the mobile station has data to send, and that it can increase its reverse data rate. The RBS(s) combine this state information with knowledge of reverse link conditions to make improved scheduling decisions.

### BACKGROUND OF THE INVENTION

The present invention generally relates to reverse link scheduling in a wireless communication network, and particularly relates to fast reverse link scheduling at the radio base station level based on receiving mobile state information.

Wireless communication networks perform various scheduling tasks associated with simultaneously serving a multiplicity of users. For example, high rate packet data services, such as those implemented in the cdma2000 and Wideband CDMA (WCDMA) standards define a common forward link channel that is time-shared between multiple users according to dynamic scheduling by the network. Even where users are assigned reverse dedicated channels, such as the assignment of separate reverse link traffic channels to individual users, scheduling of access times and durations by the multiplicity of users may be used to control overall levels of interference in the network, and the instantaneous loading of the network, which improves reverse link capacity utilization.

Indeed, in the typical CDMA-based wireless communication network, reverse link scheduling offers such advantages, but the ability to fully exploit the value of reverse link scheduling is limited by the signaling overhead involved. For example, in a typical implementation, a base station controller determines the reverse link schedule for a plurality of mobile stations, and then sends the associated scheduling decisions to those mobile stations via one or more radio base stations supporting the mobile stations. Problematically, signaling between the base station controller and the mobile stations involves relatively high-level (Layer 3) protocol processing, which imparts substantial delay to the scheduling decisions.

These signaling delays represent “control lag,” which comprises the ability of the network to maintain aggressive reverse link scheduling. That is, with its relatively slow control update rate, the network is unable to schedule reverse link activity to maintain usage at or near system capacity and interference limits. Rather, the network must employ significant “backoff” from such limits to compensate for its slow control response. Moreover, the network is denied the ability to make optimal reverse link scheduling decisions without benefit of meaningful state information from the mobile stations. Such information, which today is unavailable to the network might include which mobile stations have data ready for immediate transmission and how much such data is pending, or the mobile stations' relative ability to meet a higher than requested data rate if reverse link conditions suggest such a rate is feasible.

### SUMMARY OF THE INVENTION

The present invention comprises a method and apparatus for fast scheduling of reverse link transmission from mobile terminals. The mobile stations send mobile station state information to serving base stations. Such state information informs the base station of, for example, the amount of pending data a given mobile station has to transmit, and/or the reserve link transmit power available at a given mobile station that might be used to support an increased reverse link transmit rate from that mobile station. As the radio base station has knowledge of actual reverse link conditions between it and the mobile stations being scheduled, such state information enables the base station to make rapid, informed reverse link scheduling decisions.

By dropping reverse link scheduling operations to the base station level rather than performing such operations at a supporting base station controller, scheduling decisions do not incur the potentially significant delays attendant with signaling between the mobile station and the base station controller. Consequently, scheduling decision timeliness improves, meaning that the scheduling decisions made by the network are more closely matched to the instantaneous reverse link channel conditions and mobile station activities. Such improvements in scheduling responsiveness enable the network to more accurately control the instantaneous loading of the network and maintain that loading closer to the actual operating limits of the network.

In one or more exemplary embodiments, the mobile stations transmit their mobile station state information to the supporting base stations by multiplexing that information onto their reverse link pilot signals. Such multiplexing may be based, for example, on time-multiplexing state information onto the pilot signal such that each mobile station's pilot signal includes data and non-data portions. The receiving base stations extract the state information from the data portions of the pilot signal, and use the non-data portions, which preferably are not modulated, for channel estimation and carrier synchronization. Indeed, the amount of pilot signal “stolen” for transmission of state information preferably is bounded to ensure that enough non-data pilot signal remains for accurate channel estimation and carrier synchronization by the base stations.

While the present invention offers reverse link scheduling improvements across a variety of wireless network types, including Time Division Multiple Access (TDMA) networks and Code Division Multiple Access (CDMA) networks, the use of time-multiplexed pilot signals is particularly advantageous in CDMA systems. Examples of such networks include, but are not limited to, networks based on the cdma2000 or Wideband CDMA (WCDMA) standards. More particularly, time-multiplexing data onto the pilot signals from the mobile stations effectively provides the network with another reverse link control channel but without adding to the overall level of reverse link interference that would otherwise result from defining another spreading code channel. Moreover, the use of time multiplexing on the pilot signal avoids the need for allocating another CDMA code channel, such as an orthogonal Walsh code channel, which are in increasingly short supply in some CDMA implementations.

The present invention contemplates various approaches to time multiplexing, and such approaches include, but are not limited to, sending the pilot signal as repeating blocks of contiguous non-data and data portions, or sending it as interleaved blocks of data and non-data portions. One advantage of the latter approach is the base stations receive non-data portions spread across a given time interval, which provides a measure of fade resistance to ongoing channel estimation operations. That is, channel estimates are less prone to being biased by instantaneous fading conditions on the reverse link if the non-data portions of the pilot signals are interleaved across a given estimation interval.

Regardless of the multiplexing approach adopted, each base station receives state information from the mobile stations it supports, and makes reverse link scheduling decisions for those mobile stations based on that state information. As an example, a base station might receive an indication from a given mobile station that it has data to send on the reverse link, and might further receive an indication of available power headroom at that mobile station. With this information, and with its knowledge of the prevailing reverse link channel conditions, the base station determines the time (or times) at which to grant reverse link access to the mobile station, and at what data rate such access should be granted. For example, if the base station “sees” favorable channel conditions in combination with reserve transmit power headroom reported by the mobile, it might “up” the reverse link data rate to be used by the mobile station.

Of course, the mobile stations may include additional information or indicators in the state information sent back to their supporting base stations, and the base stations may include such information as additional considerations in determining the optimal reverse link scheduling decisions. Regardless of such details, the base stations are provided with one or more channels on the forward link so that the scheduling decision information may be transferred to the mobile stations. Depending upon the networking standard(s) used in a given wireless communication network, such information may be bundled with data on an existing control channel, or a separate channel dedicated to reverse link scheduling information may be used.

### BRIEF DESCRIPTION OF THE DRAWINGS

FIG. 1 is a diagram of an exemplary wireless communication network for supporting the present invention.

FIG. 2 is a diagram of an exemplary radio base station for use in the network of FIG. 1.

FIG. 3 is a diagram of an exemplary mobile station for use in the network of FIG. 1.

FIG. 4 is a diagram of exemplary radio base station logic for performing reverse link scheduling.

FIG. 5 is a diagram of exemplary mobile station logic for generating mobile station state information.

FIG. 6 is a diagram of exemplary mobile station logic for responding to reverse link scheduling decisions.

FIG. 7 is a diagram of exemplary methods for multiplexing mobile station state information onto a reverse link pilot signal.

### DETAILED DESCRIPTION OF THE INVENTION

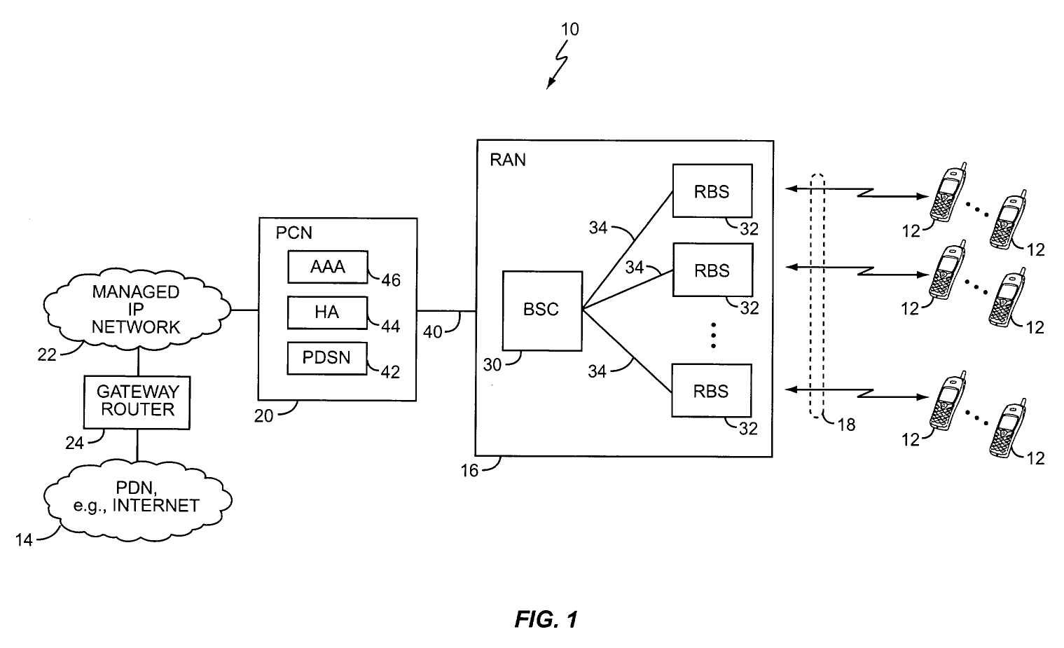

FIG. 1 illustrates an exemplary wireless communication network 10, which communicatively couples a plurality of mobile stations 12 to one or more external networks, such as Packet Data Network 14, e.g., the Internet. Network 10 includes Radio Access Network (RAN) 16, which communicates with the mobile stations 12 via wireless interface 18. In turn, RAN 16 connects with Packet Core Network (PCN) 20, which is coupled to PDN 14 through a managed IP network 22 and associated gateway router 24.

In an exemplary embodiment, RAN 16 comprises one or more base station controllers (BSCS) 30, each supporting one or more Radio Base Stations (RBSs) 32. RBSs 32 are communicatively coupled to their supporting BSC 30 via backhaul communication links 34, which typically comprise dedicated T1/E1 lines or microwave links over which traffic and control signaling data pass. In general operation, communication traffic passes between the BSC 30 and the various mobile stations 12 in essentially transparent fashion through the RBSs 32. Such traffic, along with required control signaling, then passes between RAN 16 and PCN 20 on one or more links 40. To support such signaling and control data, an exemplary PCN 20 comprises a Packet Data Serving Node (PDSN) 42, a Home Agent 44, and an Authentication, Authorization, and Accounting (AAA) server.

Regardless of the specific PCN and RAN details, scheduling of forward and reverse link transmissions to and from the various mobile stations 12 is performed at the BSC level and thus requires BSC-to-mobile station signaling. In cdma2000 network implementations, such signaling is referred to as “Layer 3” signaling because of the protocol layer involved in such signaling. Such higher-layer signaling delays the scheduling decisions, which limits the overall performance of such scheduling. In the context of the present invention, RBSs 32 perform reverse link scheduling of their supported mobile stations 12 without requiring higher level signaling to the BSC 30. That is, RBSs 32 perform reverse link scheduling at the RBS level thereby eliminating the higher-level signaling delays conventionally associated with such reverse link scheduling.

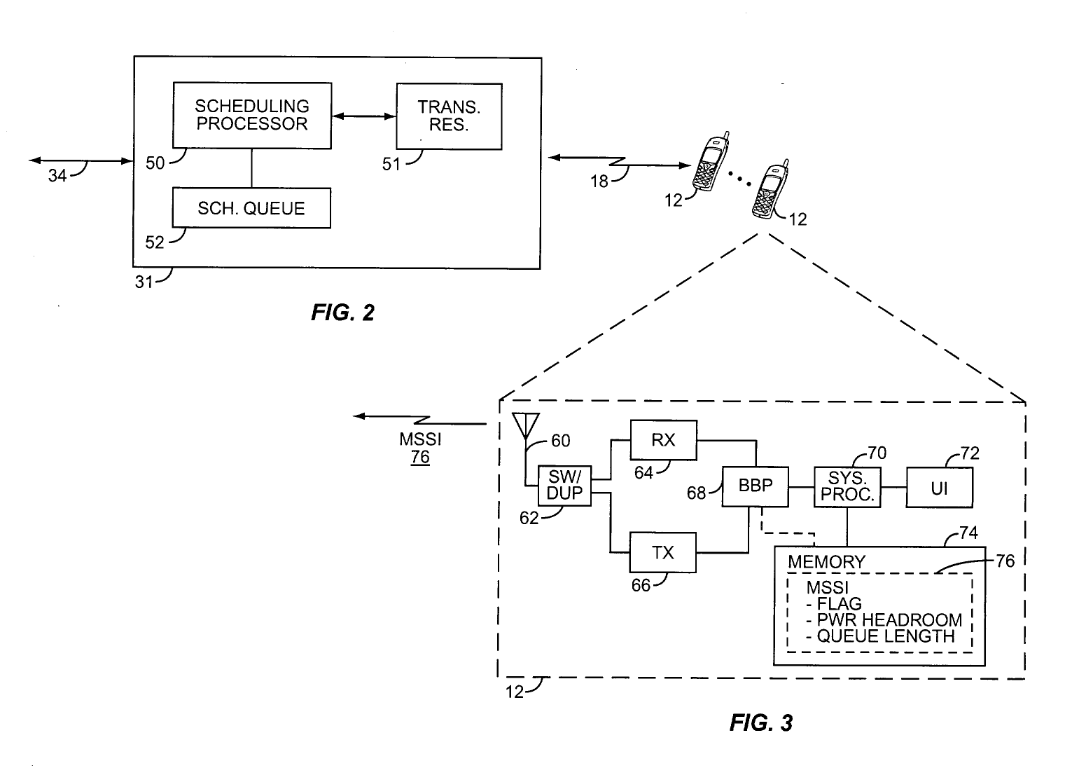

FIGS. 2 and 3 depict exemplary details for the RBSs 32 and the mobile stations 12. According to FIG. 2, an exemplary RBS 32 includes a scheduling processor 50, transceiver 51, and supporting memory 52 in which reverse link scheduling decision information may be maintained by the scheduling processor 50. Each of the mobile stations 12 supported by RBS 32 transmit a reverse link pilot signal on a reverse link of air interface 18, which is received at RBS 32 via the transceiver resources 51. As will be detailed later herein, one or more of the mobile stations 12 impress mobile station state information onto their reverse pilot signals. Thus, scheduling processor 50 in RBS 32 performs reverse link scheduling for supported mobile stations 12 based on receiving such mobile station state information. RBS 32 preferably transmits reverse link scheduling decisions via transceiver 51 on one or more forward link channels of air interface 18 such that the supported mobile stations 12 receive such scheduling information and conduct reverse link transmission according to the schedule.

FIG. 3 illustrates an exemplary mobile station 12, which comprises a receive/transmit antenna 60, a switch/duplexer 62, a receiver 64, a transmitter 66, a baseband processor 68, a system processor 70, a user interface 72, and one or more memory devices 74, which include mobile station state information (MSSI) 76. MSSI 76 may include, but is not limited to, one or more of the following items:

a status flag or other request indicator indicating whether the mobile station 12 has any data to transmit on the reverse link;

a power headroom value indicating an amount by which the mobile station 12 is able to increase its transmit power;

a queue length value indicating an amount of data that the mobile has for transmission on the reverse link.

The above components of MSSI 76 are not exhaustive and, as noted, may appear singly or in any combination. Moreover, such information may be directly accessible to baseband processor 68, or may be transferred to baseband processor 68 by the system processor 70. Regardless, baseband processor 68 and/or other processing logic within mobile station 12 operates as a multiplexer for multiplexing MSSI 76 onto the reverse link pilot signal, such that mobile station 12 transmits mobile station state information back to the network 10.

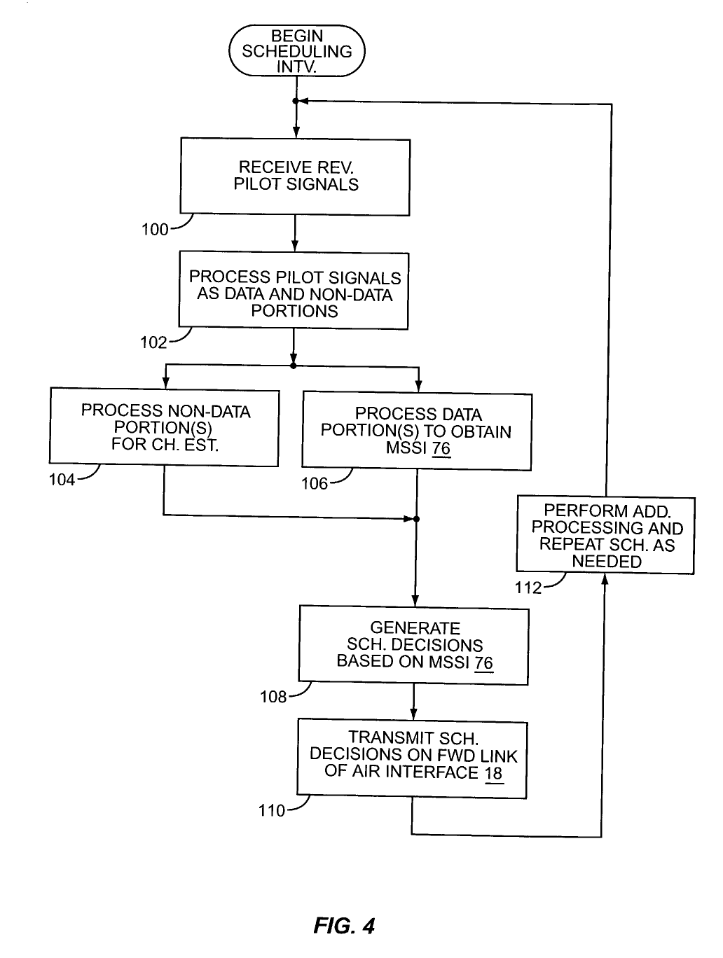

FIG. 4 illustrates exemplary scheduling reverse link scheduling logic for RBSs 32. It should be understood that RBSs 32 preferably include such logic in the form of stored computer instructions and associated processing hardware, and that such logic generally is implemented as part of larger control scheme supporting the overall operation of RBSs 32. As such other operation of RBSs 32 is generally well understood in the art and is not necessary to understanding the present invention, the following discussion focuses on exemplary reverse scheduling operations at the RBS level.

Processing begins for a given reverse link-scheduling interval with the reception of reverse link pilot signals (Step 100) from one or more mobile stations 12 supported by the RBS 32. RBS 32 processes each of these pilot signals as data and non-data portions (Step 102). More specifically, RBS 32 processes the non-data portions as an unmodulated pilot signal, which it uses for reverse link propagation channel estimation (Step 104), and processes the data portions to obtain the MSSI 76 from each of the mobile stations 12 being scheduled (Step 106). Note that RBS 32 may also receive reverse link pilot signals from mobile stations that are not adapted to transmit mobile station state information, and thus may perform scheduling of mobile stations for which it has state information and mobile stations for which it does not have state information.

In any case, RBS 32 generates its reverse link scheduling decisions based on the MSSI 76 received from each of the mobile stations 12 using its scheduling processor 50 (Step 108), and without need for scheduling intervention by BSC 30. Because RBS 32 uses the non-data portions of the reverse pilot signals received from the mobile stations 12 for channel estimation, it is uniquely well positioned for computing the actual reverse link channel conditions between it and the various mobile stations 12. Thus, it may combine its knowledge of the various mobile states with that channel information to make particularly well-informed reverse link scheduling decisions. For example, a given one of the mobile stations 12 might indicate that it has a substantial amount of reverse link traffic queued for transmission, which would otherwise make it a prime candidate for reverse link scheduling. However, RBS 32 may see that the reverse link channel conditions between it and that mobile station 12 are particularly poor and thus defer scheduled transmissions from that mobile station 12 until the specific channel conditions improve.

Once RBS 32 has determined the appropriate scheduling decisions for the scheduling interval of interest, it transmits the scheduling decisions on a forward link of air interface 18 for reception at the various mobile stations 12 (Step 110). Processing then continues as needed, and with repeated scheduling as needed (Step 112). The forward link transmission of scheduling decisions may involve the use of a forward link air interface channel dedicated to the transmission of such scheduling information, or such scheduling information may be combined with data on another existing forward link channel.

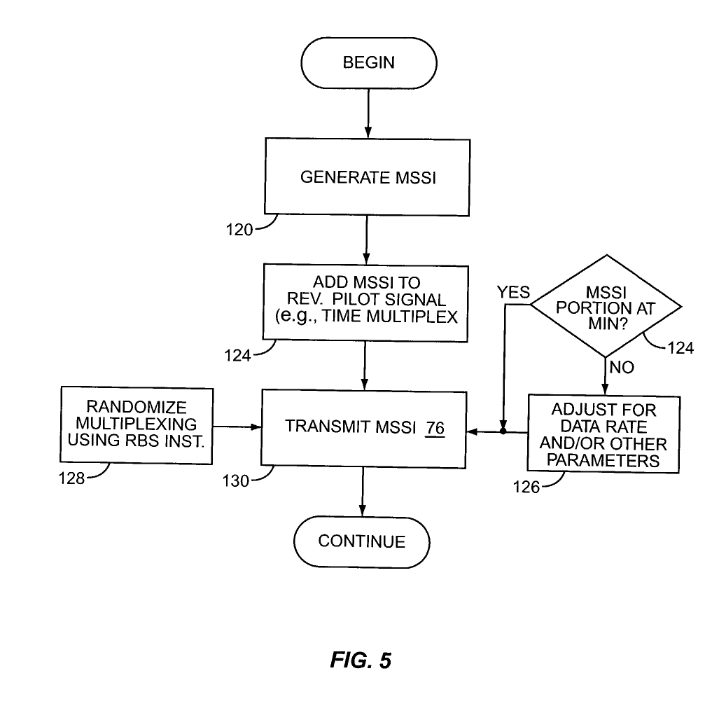

FIG. 5 illustrates exemplary operating logic for the mobile stations 12. Processing begins with a mobile station 12 generating state information (MSSI 76) for a given scheduling interval (Step 120). Mobile station 12 then multiplexes, such as by time multiplexing, the state information with its reverse pilot signal (Step 122). Such multiplexing may be simple, such as where the mobile station replaces a fixed time portion of the pilot signal with the state information. However, the present invention contemplates a variety of multiplexing options, which may yield various operational advantages.

For example, mobile station 12 may consider whether the portion (time percentage) of the pilot signal currently given over to mobile state information is at a minimum allocation (Step 124). If so, the mobile station simply uses that minimum allotment of time to send the state information on the pilot signal. However, if the mobile station is currently using a greater than minimum portion of the pilot signal for state information, it may adjust downward that amount used in consideration of its current or anticipated reverse link data rate (Step 126). Thus, when the mobile station 12 anticipates transmitting at a relatively high reverse link data rate, it may decrease the amount of pilot signal given over to mobile state information. Such a decrease is advantageous because it provides the receiving RBS 32 with an increased amount of unmodulated pilot signal for channel estimation. The need for improved channel estimation at the RBS 32 generally increases as the mobile station 12 increases its reverse data rate.

Further, the overall performance of network 10 may be improved by having the various mobile stations 12 randomize the times at which each individually transmits its MSSI 76 to the supporting RBSs 32. Thus, in one or more embodiments, RBSs 32 transmit random time values to the mobile stations 12, or transmit randomization seeds controlling such time values, so that different mobile stations 12 use different time multiplexing for transmitting the MSSI 76 to the RBSs 32.

Regardless of the nuances applied to the multiplexing of mobile state information with the reverse link pilot signal, each mobile station 12 transmits its MSSI 76 to its supporting RBS 32 (Step 130) and processing continues as needed. Note that the continuation of processing includes performing other ongoing mobile station operations and generally includes repeating the transmission of MSSI 76 to the supporting RBS 32 in support of repeated scheduling interval operations at the RBS 32.

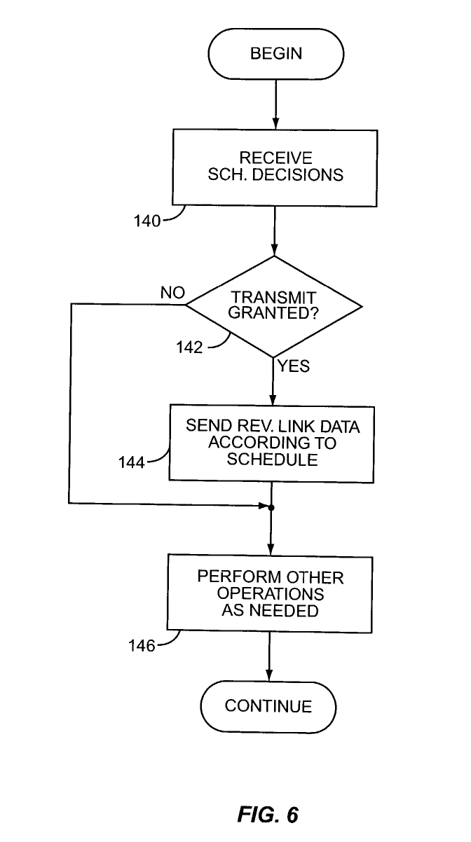

FIG. 6 illustrates exemplary processing logic for mobile stations 12 as regards receiving and responding to reverse link-scheduling decisions transmitted by a supporting RBS 32. Processing begins with a mobile station 12 receiving scheduling decision information from its supporting RBS 32 on a defined forward link channel of air interface 18 (Step 140). Assuming the mobile station has data to transmit on the reverse link, it processes the received scheduling information to determine whether it has been granted permission to transmit on the reverse link (Step 142). If so, mobile station 12 sends all or a portion of its pending reverse link transmit data according to the specifics of the scheduling decision information received by it (Step 144). Such specifics may include the rate and specific time(s) at which the mobile station 12 should transmit.

If permission is not granted, the mobile station 12 generally defers sending its reverse link data, although such deferral may be overridden by the mobile station 12 for certain types of reverse link traffic, or beyond a certain delay limit. In either case, the mobile station 12 continues with other processing operations as needed (Step 146).

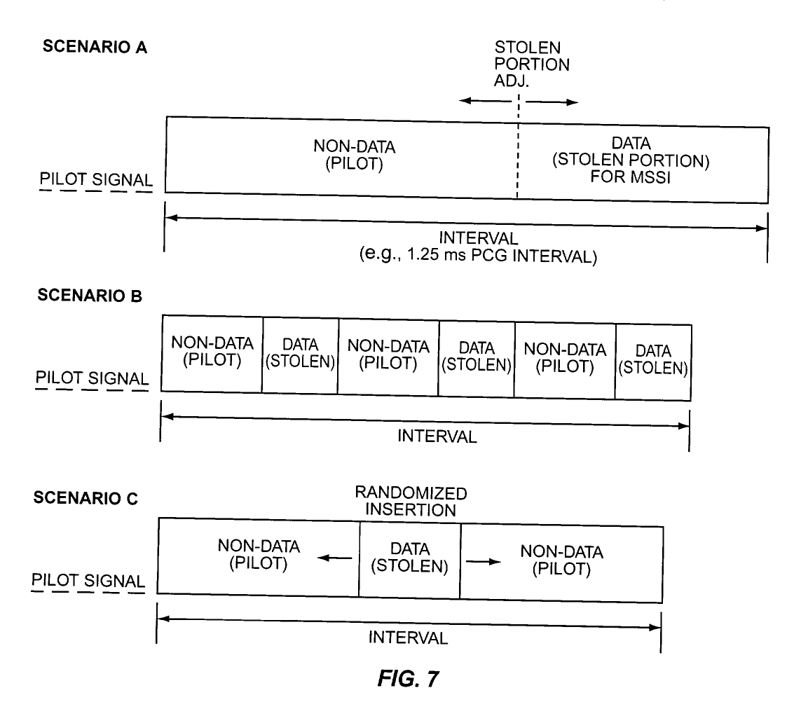

Of course, the processing logic described above for the RBSs 32 and the mobile stations 12 is subject to alteration as needed or desired. For example, the discussion related to FIG. 5 indicated that the mobile stations 12 might perform different multiplexing operations for the MSSI 76. FIG. 7 illustrates exemplary variations on such multiplexing operations, but the variations shown in FIG. 7 are not meant as an exhaustive depiction of all multiplexing possibilities.

Scenario A of FIG. 7 illustrates a relatively straightforward division of the reverse pilot signal into a contiguous non-data portion and a contiguous data portion over a given interval of the pilot signal. A convenient scheduling interval, and one that is made practical with the present invention's location of reverse link scheduling at the RBS level, is the Power Control Group (PCG) interval of 1.25 milliseconds as defined by cdma2000 standard. Thus, where network 10 comprises a cdma2000-based wireless network, the RBSs 32 may perform scheduling decisions at repeating PCG intervals.

Regardless of the interval used, one notes that the illustration indicates that the division between non-data and data portions is adjustable. That is, the percentage of the pilot signal given over to data (MSSI 76) may be varied as a function of reverse link transmit rate, for example. With such an approach, mobile stations 12 might individually vary the percentage of pilot signal “stolen” for sending MSSI 76 as a function of reverse transmit rate. With such an arrangement, there may be a pre-defined set of percentages mapped to defined data rates, such that the RBSs 32 know a priori the percentage of pilot signal used for MSSI 76 by a given mobile station 12 based on its reverse data rate.

Scenario B illustrates an alternative to the contiguous block approach of Scenario A, wherein the data portions of the pilot signal are interleaved with non-data portions of the pilot signal. In this manner, the RBS 32 receives spaced apart non-data portions of the reverse link pilot signal across the entire interval. By spacing the non-data portions in this fashion, the RBS 32 can perform reverse link channel estimation using the non-data portions of the pilot signal at time instances spread across the interval, which may yield improvements in channel estimation by eliminating sensitivity to instantaneous channel fading, for example.

Finally, Scenario C illustrates inserting the data portion into the non-data portion of the pilot signal at a randomized insertion point. As noted, RBSs 32 may provide randomization information to each mobile station 12 about how it should randomize the insertion of its mobile station state information onto the reverse link pilot signal. In this manner, mobile stations 12 transmit state information at different times, which may reduce potential interference in network 10.

Regardless of whether any of these more sophisticated multiplexing operations are exercised, the present invention uses the reverse link pilot signals from mobile stations 12 to convey mobile station state information to the RBSs 32 supporting those mobile stations 12. Based on that state information, and preferably in consideration of the actual reverse link conditions associated with the individual mobile stations 12, each RBS 32 performs reverse link scheduling at the RBS level without need for higher level control signaling to the BSC 30.

By localizing such reverse link scheduling at the RBS level, the present invention avoids the scheduling lags that would otherwise be incurred with the involvement of the BSC 30. Thus, the present invention provides for fast reverse link scheduling with concomitant improvements in network performance and utilization efficiency. Therefore, the present invention is not limited by the foregoing discussion but rather is limited only by the appended claims and the reasonable equivalence thereof.

What is claimed is:

1. A method of reverse link scheduling in a wireless communication network comprising:
receiving mobile station state information from a plurality of mobile stations at a radio base station in the wireless communication network;
determining reverse link scheduling decisions at the radio base station based on the received state information; and
transmitting the scheduling decisions from the radio base station to the mobile stations.

2. The method of claim 1, wherein receiving mobile station state information from a plurality of mobile stations at a radio base station comprises receiving at least one of reverse link data queue information and reverse link power headroom information from each mobile station.

3. The method of claim 2, wherein determining reverse link scheduling decisions at the radio base station based on the received state information comprises granting reverse link access to given ones of the mobile stations at data rates determined from the reverse link power headroom information received from those given ones of the mobile stations.

4. The method of claim 2, wherein determining reverse link scheduling decisions at the radio base station based on the received state information comprises granting reverse link access to given ones of the mobile stations at scheduling times determined from the data queue length information received from those given ones of the mobile stations.

5. The method of claim 1, wherein receiving mobile station state information from a plurality of mobile stations at a radio base station in the wireless communication network comprises:
receiving pilot signals from the plurality of mobile stations; and
extracting the state information for each mobile station from the pilot signal received from that mobile station.

6. The method of claim 5, wherein extracting the state information for each mobile station from the pilot signal received from that mobile station comprises extracting time-division multiplexed information from the pilot signal.

7. The method of claim 5, wherein each pilot signal time-wise comprises at least one non-data portion and at least one data portion, and wherein extracting the state information for each mobile station from the pilot signal received from that mobile station comprises processing the at least one data portion to obtain the state information.

8. The method of claim 7, further comprising estimating reverse link channel conditions for each mobile station using the at least one non-data portion of the pilot signal from that mobile station.

9. The method of claim 1, wherein determining reverse link scheduling decisions at the radio base station based on the received state information comprises processing the received state information jointly to determine a reverse link access schedule for the mobile stations.

10. The method of claim 9, wherein transmitting the scheduling decisions from the radio base station to the mobile stations comprises transmitting access grant information to the mobile stations to control the times and duration of reverse link accesses by the mobile stations in accordance with the reverse link access schedule determined by the radio base station.

11. A method of facilitating reverse link scheduling by a wireless communication network comprising:
determining mobile station state information at a mobile station;
multiplexing the state information onto a reverse link pilot signal; and
transmitting the pilot signal including the state information to a radio base station in the wireless communication network for use in scheduling reverse link accesses by the mobile station.

12. The method of claim 11, wherein determining mobile station state information at a mobile station comprises the mobile station determining an amount by which the mobile station can increase its reverse link transmit power.

13. The method of claim 12, wherein the mobile station determines the amount by which the mobile station can increase its reverse link transmit power by calculating a reverse link transmit power headroom.

14. The method of claim 11, wherein determining mobile station state information at a mobile station comprises the mobile station determining a reverse link data queue length.

15. The method of claim 11, wherein multiplexing the state information onto a reverse link pilot signal comprises time-multiplexing the state information onto the pilot signal such that the pilot signal has one or more non-data portions and one or more data portions.

16. The method of claim 15, wherein time-multiplexing the state information comprises interleaving non-data and data portions of the pilot signal over a given time interval.

17. The method of claim 15, wherein time-multiplexing the state information comprises transmitting a contiguous non-data portion and a contiguous data portion of the pilot signal over a given time interval.

18. The method of claim 15, further comprising adjusting a proportion of data and non-data portions of the pilot signal based on a reverse link data rate.

19. The method of claim 18, wherein adjusting a proportion of data and non-data portions of the pilot signal based on a reverse link data rate comprises lowering the proportion as the reverse link data rate from the mobile station increases.

20. A radio base station for use in a wireless communication network comprising:
transceiver resources to receive mobile station state information from a plurality of mobile stations on an air interface reverse link, and to transmit reverse link scheduling decisions to those mobile stations on a forward link of the air interface; and
a scheduling processor to determine the scheduling decisions based on the mobile station state information received from each of the mobile stations.

21. The radio base station of claim 20, wherein the radio base station receives at least one of data queue length information and transmit power headroom information as part of the mobile station state information transmitted from each mobile station.

22. The radio base station of claim 21, wherein the radio base station generates scheduling decisions as access grant information that controls reverse link access by the mobile stations.

23. The radio base station of claim 22, wherein the radio base station determines the access grant information as at least one of ordered access times, access durations, and transmit data rates for the mobile stations based on at least one of the transmit power headroom information and data queue length information received from the mobile stations.

24. The radio base station of claim 21, wherein determining reverse link scheduling decisions at the radio base station based on the received state information comprises granting reverse link access to given ones of the mobile stations at scheduling times determined from the data queue length information received from those given ones of the mobile stations.

25. The radio base station of claim 20, wherein the radio base station receives the mobile station state information based on:
receiving pilot signals from the mobile stations; and
extracting the mobile station state information for each mobile station from the pilot signal received from that mobile station.

26. The radio base station of claim 25, wherein the radio base station extracts the state information for each mobile station from the pilot signal received from that mobile station by time demultiplexing the pilot signal.

27. The radio base station of claim 25, wherein each pilot signal time-wise comprises at least one non-data portion and at least one data portion, and wherein the radio base station demultiplexes the data and non-data portions, and processes the data portion to obtain the mobile station state information.

28. The radio base station of claim 27, wherein the radio base station estimates reverse link channel conditions for each mobile station using the at least one non-data portion of the pilot signal from that mobile station.

29. The radio base station of claim 20, wherein the radio base station determines the scheduling decisions based on jointly processing the state information from the mobile stations to determine a reverse link access schedule for the mobile stations.

30. A mobile station for use in a wireless communication network comprising:
a processor to determine mobile station state information to support reverse link transmit scheduling by the network;
a multiplexer to multiplex the state information onto a pilot signal; and
a transmitter to transmit the multiplexed pilot signal to the network.

31. The mobile station of claim 30, wherein the mobile station determines an amount by which the mobile station can increase its reverse link transmit power as at least part of the state information transmitted to the network.

32. The mobile station of claim 31, wherein the mobile station determines the amount by which the mobile station can increase its reverse link transmit power by calculating a transmit power headroom value.

33. The mobile station of claim 30, wherein the mobile station determines a reverse link data queue length as at least part of the state information transmitted to the network.

34. The mobile station of claim 30, wherein the mobile station sets a request indicator indicating whether the mobile station has data for transmission on the reverse link as at least part of the state information transmitted to the network.

35. The mobile station of claim 30, wherein the mobile station multiplexes the state information onto a reverse link pilot signal by time-multiplexing the state information onto the pilot signal such that the pilot signal has one or more non-data portions and one or more data portions.

36. The mobile station of claim 35, wherein the mobile station time-multiplexes the state information by interleaving non-data and data portions of the pilot signal over a given time interval.

37. The mobile station of claim 35, wherein the mobile station time-multiplexes the state information by transmitting a contiguous non-data portion and a contiguous data portion of the pilot signal over a given time interval.

38. The mobile station of claim 35, wherein the mobile station adjusts a proportion of the data and non-data portions of the pilot signal based on a reverse link data rate.

39. The mobile station of claim 38, wherein the mobile station adjusts the proportion of data and non-data portions of the pilot signal by lowering the proportion as the reverse link data rate from the mobile station increases.
